(19) United States
(12) Patent Application Publication
(10) Pub. No.: US 2026/0106731 A1
(43) Pub. Date: Apr. 16, 2026

(54) ENCRYPTION OF CONTAINER IMAGE LAYERS DETERMINED TO HAVE SENSITIVE DATA

(71) Applicant: International Business Machines Corporation, Armonk, NY (US)

(72) Inventors: Peng Hui Jiang, Beijing (CN); Prabhat Ranjan, Bangalore (IN); Dileep Dixith, Hyderabad (IN); Abhiram Kulkarni, Bengaluru (IN); Sainath Sativar, Hyderabad (IN); Sowmya Parvathi, Bengaluru (IN)

(21) Appl. No.: 18/915,131

(22) Filed: Oct. 14, 2024

(51) Int. Cl. H04L 9/08

(52) U.S. Cl. CPC H04L 9/0825

(57) ABSTRACT

A method, according to one embodiment, includes generating an encryption key pair within a secure execution virtual machine, where the encryption key pair includes a private key and a public key. The method further includes storing the private key within the secure execution virtual machine, and determining whether any layers of a first container image contain sensitive data. In response to a determination that a first of the layers of the first container image includes the sensitive data, the public key is used to encrypt the first layer. In response to receiving a request for the first container image, the private key is used to decrypt the first layer in the secure execution virtual machine. A computer program product, according to another embodiment, includes one or more computer-readable storage media, and program instructions stored on the one or more storage media to perform the foregoing method.

### BACKGROUND

The present invention relates to sensitive data, and more specifically, this invention relates to encryption keys.

A container image is a static file with executable code that can create a container on a computing system. A container image is immutable, meaning the container image cannot be changed, and may be deployed consistently in any environment. Container images include everything that a container needs to run, e.g., the container engine, system libraries, utilities, configuration settings, specific workloads that are to be run on the container, etc.

### SUMMARY

A method, according to one embodiment, includes generating an encryption key pair within a secure execution virtual machine, where the encryption key pair includes a private key and a public key. The method further includes storing the private key within the secure execution virtual machine, and determining whether any layers of a first container image contain sensitive data. In response to a determination that a first of the layers of the first container image includes the sensitive data, the public key is used to encrypt the first layer. In response to receiving a request for the first container image, the private key is used to decrypt the first layer in the secure execution virtual machine.

A computer program product, according to another embodiment, includes one or more computer-readable storage media, and program instructions stored on the one or more storage media to perform the foregoing method.

A computer system, according to another embodiment, includes a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an architecture of a secure execution virtual machine, in accordance with one embodiment.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for encryption of container image layers determined to have sensitive data.

In one general embodiment, a method includes generating an encryption key pair within a secure execution virtual machine, where the encryption key pair includes a private key and a public key. The method further includes storing the private key within the secure execution virtual machine, and determining whether any layers of a first container image contain sensitive data. In response to a determination that a first of the layers of the first container image includes the sensitive data, the public key is used to encrypt the first layer. In response to receiving a request for the first container image, the private key is used to decrypt the first layer in the secure execution virtual machine.

In another general embodiment, a computer program product includes one or more computer-readable storage media, and program instructions stored on the one or more storage media to perform the foregoing method.

In another general embodiment, a computer system includes a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as sensitive data layer encryption code of block 150 for encryption of container image layers determined to have sensitive data. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

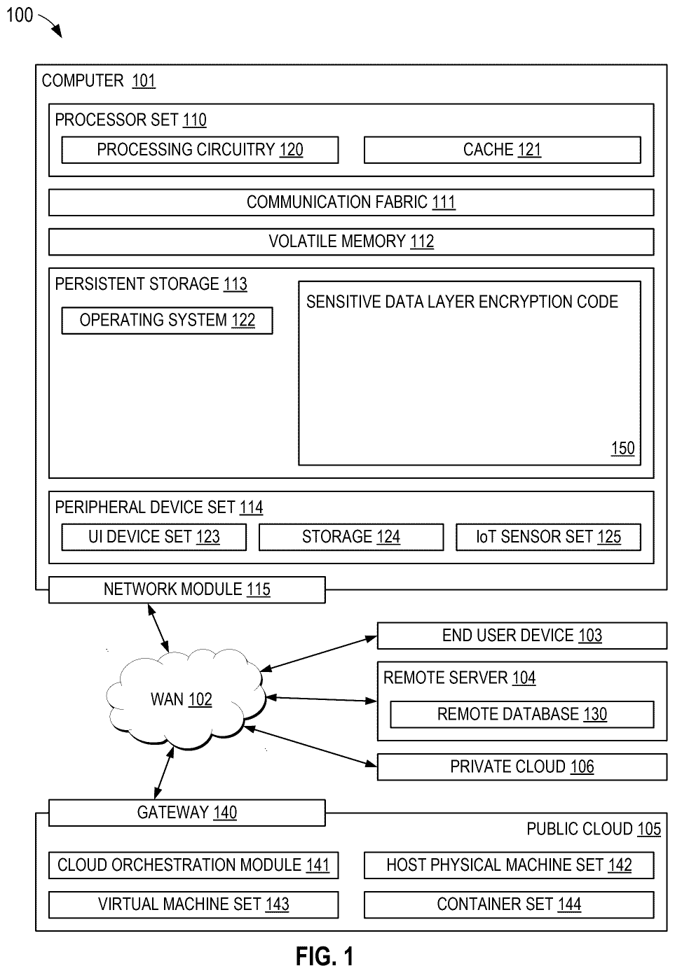

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (eud) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a container image is a static file with executable code that can create a container on a computing system. A container image is immutable, meaning the container image cannot be changed, and may be deployed consistently in any environment. Container images include everything that a container needs to run, e.g., the container engine, system libraries, utilities, configuration settings, specific workloads that are to be run on the container, etc.

A container image is composed of layers, added on to a parent image (also known as a base image). Layers make it possible to reuse components and configurations across images. Constructing layers in an optimal manner can help reduce container size and improve performance.

A virtual private cloud (VPC) is a public cloud offering that lets an enterprise establish its own private cloud-like computing environment on shared public cloud infrastructure. A VPC provides an enterprise with the ability to define and control a virtual network that is logically isolated from all other public cloud tenants, creating a private, secure place on the public cloud.

Within conventional VPC environments, user devices can be used to extract or untar any container image, thereby revealing all the files and a directory of the container image. In many cases the container image includes sensitive data or code. This creates a security issue as most coding languages allow the code to be accessed even before a start of the container. In other words, sensitive data is subject to being exploited by loopholes that exist in conventional container image use practices.

In sharp contrast to the deficiencies described above, the techniques of embodiments and approaches described herein securely build a container image and encrypt the container image to protect the container image from any sensitive information leakage or exploitation. This protects code of the container image as well as a private key used to encrypt the container image using the confidential computing environment. These techniques include identifying whether a container image has any sensitive data by using scanning tools or mechanisms, and then providing operations for securely building the container image using a secure build process. This build process does not include any human intervention and offers a granularity based protection for the container image by encrypting select layers of the container image.

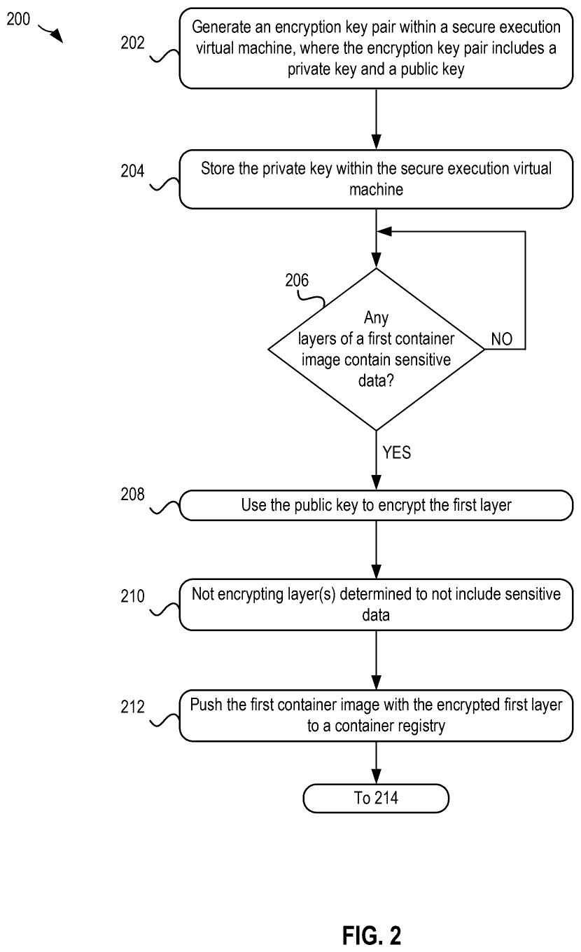

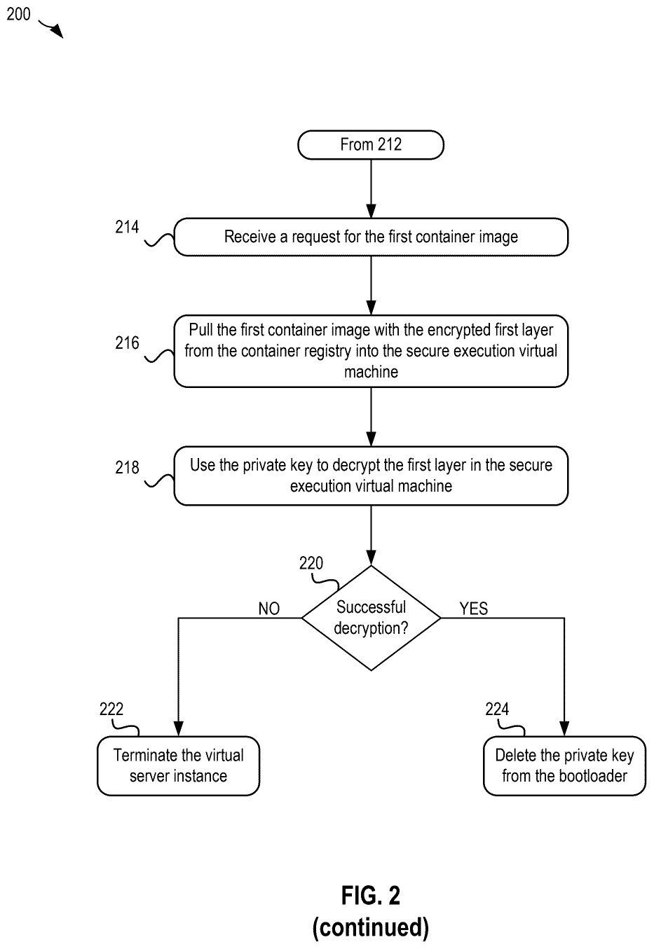

Now referring to FIG. 2, a flowchart of a method 200 is shown according to one embodiment. The method 200 may be performed in accordance with aspects of the present invention in any of the environments depicted in FIGS. 1-4, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes generating an encryption key pair that includes a private key and a public key, e.g., an asymmetric encryption key pair. In some preferred approaches, the encryption key pair is generated within a secure execution virtual machine. For example, in some approaches, the encryption key pair may be generated by a secure execution virtual machine that includes infrastructure that hosts and/or manages a confidential computing environment. For context, in some approaches, confidential computing refers to cloud computing technology that enables data to be isolated from being accessed while being processed. With respect to the infrastructure mentioned above, the cloud computing technology may exist within a CPU. In some preferred approaches, data and/or computing performed within this portion of the CPU is not accessible to user devices (such as user devices being used by humans attempting to maliciously intercept the data of the confidential computing environment). Instead, in some approaches, the data and/or computing may only be accessible to authorized code, e.g., privileged accesses. The confidential computing environment may otherwise be undiscoverable by any program or person.

The encryption key pair may be generated using techniques that would become apparent to one of ordinary skill in the art after reading the descriptions herein.

Operation 204 includes storing the private key within the secure execution virtual machine. For context, the private key is stored within the secure execution virtual machine to ensure that the private key is not intercepted and/or obtained by an unauthorized device. More specifically, as will be described in further detail elsewhere herein, the private key is stored within the secure execution virtual machine to thereafter be used for decryption operations performed within the secure execution virtual machine.

In some approaches, the private key may be stored within a predetermined portion of the secure execution virtual machine. For example, in one or more of such approaches, the secure execution virtual machine may include a bootloader, which may be a program that loads an operating system (such as a predefined virtual portion of the CPU) into a device's memory when the operating system is first turned on. Accordingly, in some approaches, storing the private key within the secure execution virtual machine may include injecting the private key into the bootloader of the secure execution virtual machine, e.g., using injection techniques that would become apparent to one of ordinary skill in the art after reading the descriptions herein. The secure execution virtual machine may additionally and/or alternatively include the operating system that is selectively loaded, as mentioned above. In some approaches, the operating system may include a virtual server instance (VSI) by INTERNATIONAL BUSINESS MACHINES CORPORATION (IBM).

The secure execution virtual machine may additionally and/or alternatively be a protected CPU enclave (a secure enclave environment). More specifically, the protected CPU enclave may be configured to isolate data during processing such that the data is not accessible by a human using a user device in an attempt to access the data.

In contrast, the public key may, in some approaches, be output from the secure execution virtual machine to a predetermined encryption engine that is configured to be caused, e.g., instructed, to use the public key to encrypt data.

With reference now to decision 206, in some approaches, one or more container images may be evaluated to determine whether the container images contain sensitive data. It should be noted that, although various descriptions herein refer to a “first container image”, the techniques described herein may may additionally and/or alternatively be serially and/or sequentially performed with respect to a plurality of container images.

A determination of whether any layers of a first container image contain sensitive data may, in some approaches, include scanning the different layers of the container image for predetermined types of sensitive data. This scanning may, in some approaches, be performed by using static analysis tools configured to scan container images. Such tools may include using a comprehensive and versatile scanner such as Trivy. In some other approaches, the tools may additionally and/or alternatively include Clair. In some other approaches, the scanning may be performed by using dynamic analysis tools, e.g., such as Twistlock. In yet some further approaches, the scanning may additionally and/or alternatively be performed by first training and then deploying an AI based technology that is trained to search container image layers for predetermined types of sensitive data. For example, such an AI based technology may, in some approaches, include a natural language processing (NLP) engine that is trained until reaching a predetermined threshold of accuracy and then deployed for scanning the first container image. In some other approaches, the AI based technology may additionally and/or alternatively include a named entity recognition analysis of a type that would become apparent to one of ordinary skill in the art after reading the descriptions herein.

The type of sensitive data may depend on the approach and/or an environment in which the container image is used in. According to some approaches, the sensitive data may include, e.g., an application programming interface (API) key, a secret, a proprietary code, a proprietary configuration, confidential data files, confidential documents, etc. For context, a document, data file, etc., may, in some approaches, be “confidential” based on one or more predetermined conditions being met, e.g., a predetermined flag being set, the document being password protected, the data file being stored on a server that subjects user devices to an authentication login process, etc. In addition to and/or alternative to a scan being performed on the layers of the first container image, predetermined types of operations may be performed in a testing sequence in which an attempt is made to exploit potential loopholes of the code of the container image, e.g., which can lead to security exploitation. Specifically, this testing sequence may include operations that attempt to gain unauthorized access to the code of the container image and/or contents of the container image, but that do not corrupt or change a state of the code in response to successfully gaining unauthorized access to the code of the container image.

In some approaches, a knowledge base of identified patterns may be established and used to reduce an amount of processing resources that scanning each of the layers of the first container image consumes. For example, in one or more of such approaches, method 200 may include gathering information used to identify a pattern of the sensitive data in one of the layers of the first container image, e.g., the first layer in the first container image. Data pattern identification techniques of a type that would become apparent to one of ordinary skill in the art after reading the descriptions herein may be used to identify the pattern of the sensitive data. The gathered information may, in some approaches, identify types of sensitive data that were identified in the first layer, a size of documents and/or files determined to include the sensitive data, owners of the documents and/or files determined to include the sensitive data, etc. The gathered information may be stored in a knowledge base. This way, the identified pattern may be used to perform a similarity comparison (such as cosine similarity and/or other comparison techniques of a type that would become apparent to one of ordinary skill in the art after reading the descriptions herein) of the first layer and other layers in the first container image, e.g., the other layers including a second layer of the first container image, a third layer of the first container image, etc.

In response to a determination that any one or more of the layers of the first container image contain sensitive data and/or are subject to being exploited for security threats (via loopholes), these layer(s) are eligible for container protection, e.g., as will be described in further detail blow in operation 208. In contrast, in response to a determination that none of the layers of the first container image contain sensitive data and/or are subject to being exploited for security threats (via loopholes), e.g., as illustrated by the “NO” logical path of decision 206, the method optionally ends. In some alternative approaches, in response to the determination that none of the layers of the first container image contain sensitive data and/or are subject to being exploited for security threats (via loopholes), method 200 includes optionally continuing to monitor for one or more of the layers of the first container image containing sensitive data.

In response to a determination (based on results of the scanning and/or comparison analysis) that a first of the layers of the first container image includes the sensitive data, the public key is, in some preferred approaches, used to encrypt the first layer of the first container image, e.g., see operation 208. Similarly, any other layers of the first container image that are determined (based on results of the scanning and/or comparison analysis) to include the sensitive data are also encrypted using the public key. However, to reduce an amount of processing resources expended in protecting a security of the first container image, in preferred approaches, the layers of the first container image that are determined to not include sensitive information are not encrypted using the public key, but instead left in an unencrypted state, e.g., see operation 210. For example, in response to a determination, based on results of the scanning, that a second of the layers of the first container image does not include the sensitive data, the public key is not used to encrypt the second layer of the first container image. Meanwhile, in a further example, in response to a determination based on results of the scanning that the third layer of the first container image includes the sensitive data, the public key is used to encrypt the third layer of the first container image.

In some approaches, the public key may be output from the secure execution virtual machine to a customer device that then uses the public key (during a secure build of a container image) to encrypt layers of a container image determined to include and/or known to include sensitive information before returning the container image.

Operation 212 includes pushing the first container image with the encrypted first layer to a container registry. The container registry may, in some approaches, be located outside of the secure execution virtual machine and be created and maintained for storing container images until they are requested for use. In some approaches, the container registry includes the first container image and/or a copy of the first container image. In some other approaches, the container registry includes a pointer that points to a storage location of the first container image.

Operation 214 includes receiving a request for the first container image. In some approaches, the request may be received from a user device of a customer that owns the first container image. Furthermore, in some approaches, the request may be received by a processor that queues requests for container images that are then fulfilled using techniques described below.

In response to receiving the request for the first container image, method 200, in some approaches, includes pulling the first container image with the encrypted first layer (and any other encrypted or nonencrypted layers) from the container registry into the secure execution virtual machine to decrypt the encrypted layer(s) in the secure execution virtual machine, e.g., see operation 216. In some approaches, the first container image is caused to be pulled, e.g., instructed, from the bootloader of the secure execution virtual machine, which may be a bootloader configured specifically for the first container image.

In response to receiving the request for the first container image, method 200 includes using the private key to decrypt the first layer in the secure execution virtual machine, e.g., see operation 218. Furthermore, any other encrypted layers of the first container image (encrypted using the public key) may be decrypted using the private key. This decryption creates an unencrypted version of the container image in the secure execution virtual machine that may be used, e.g., a customer device may be provided access to the decrypted first container image thereby allowing the customer device to run the decrypted first container image. Meanwhile, the private key is not vulnerable to being compromised as the private key remains in the secure execution virtual machine.

In some approaches, a determination may be made as to whether the decryption is successfully performed or not, as some cases of decryption may fail thereby resulting in layer(s) of the first container not being decrypted. Decision 220 includes determining whether the decryption is successful. Such a determination may be performed by performing a check that verifies whether the contents of each of the layers of the first container image are accessible.

In response to a determination that the first layer (and all other layers encrypted using the public key) is successfully decrypted in the secure execution virtual machine, the private key is deleted from the bootloader because the container image is ready to be used, e.g., see operation 224.

In some approaches, this determination as to whether the decryption is successfully performed may be made with respect to a virtual server instance. For example, in some approaches, the private key is used to decrypt the first layer in the secure execution virtual machine during provisioning of a virtual server instance on the secure execution virtual machine. Such an instance may, in some approaches, be virtual server that runs in the secure execution virtual machine to provide infrastructure that can be used for computer operations such as hosting websites and web applications, running enterprise applications, hosting databases, running batch jobs, and/or other purposes. In such approaches, in response to a determination that the first layer is unsuccessfully decrypted in the secure execution virtual machine, the virtual server instance may be terminated, e.g., see operation 222.

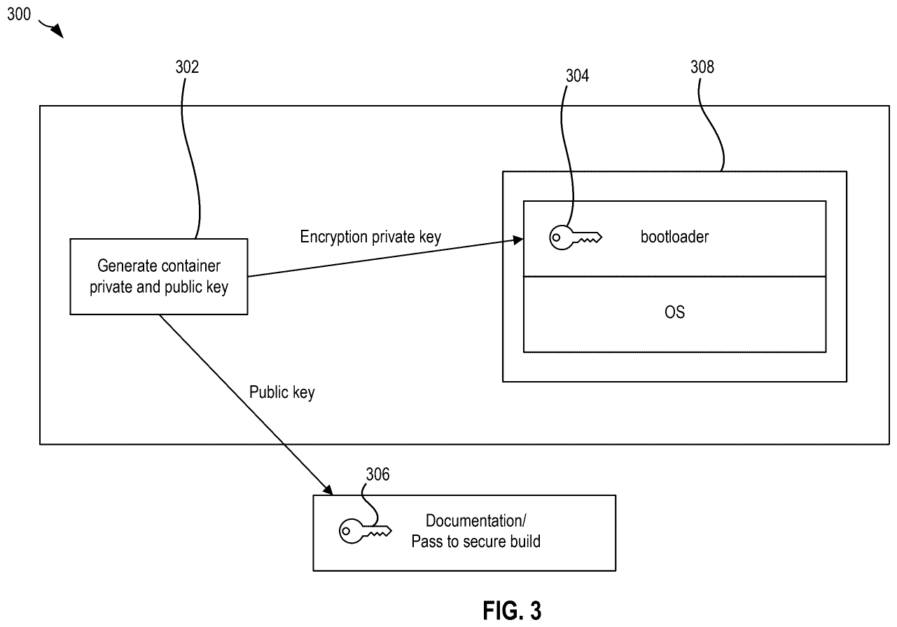

FIG. 3 depicts an architecture of a secure execution virtual machine 300, in accordance with one embodiment. As an option, the present secure execution virtual machine 300 may be implemented in conjunction with features from any other embodiment listed herein, such as those described with reference to the other FIGS. Of course, however, such secure execution virtual machine 300 and others presented herein may be used in various applications and/or in permutations which may or may not be specifically described in the illustrative embodiments listed herein. Further, the secure execution virtual machine 300 presented herein may be used in any desired environment.

An encryption key pair, that includes a private key 304 and a public key 306, may be generated in the secure execution virtual machine 300. The encryption key pair may be generated by a sub-component of the secure execution virtual machine 300 (see generate container 302) using techniques that would become apparent to one of ordinary skill in the art after reading the descriptions herein.

In some approaches, the private key is stored within the secure execution virtual machine. More specifically, the private key may be stored within a predetermined portion of the secure execution virtual machine. For example, in one or more of such approaches, the secure execution virtual machine may include a bootloader and operating system resources (see OS) of a container image 308. In some approaches, storing the private key within the secure execution virtual machine may include injecting the private key into the bootloader of the secure execution virtual machine, e.g., using injection techniques that would become apparent to one of ordinary skill in the art after reading the descriptions herein. Furthermore, the public key may be passed, e.g., output to a customer device, to be used for a predetermined documentation and/or secure build process in which layers of a container image that contain sensitive data are encrypted using the public key.

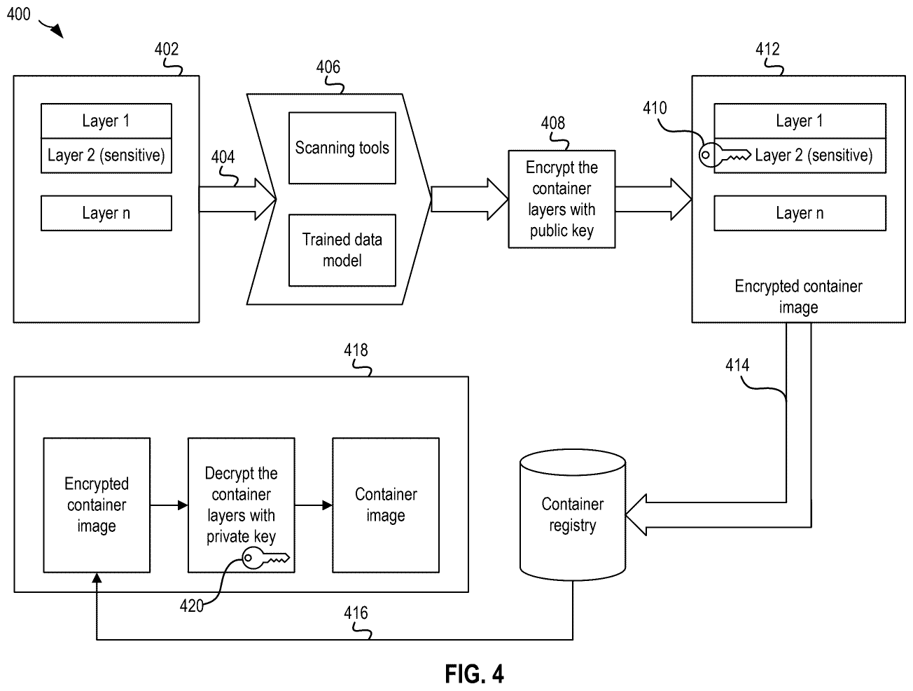

Now referring to FIG. 4, a flowchart of a method 400 is shown according to one embodiment. The method 400 may be performed in accordance with aspects of the present invention in any of the environments depicted in FIGS. 1-4, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

In operation 404, an unencrypted container image 402 is processed for determining whether any of the layers of the container image include sensitive information. For example, in some approaches, the unencrypted container image 402 may be processed by infrastructure 406 that includes a trained AI model. In some other approaches, the processing may additionally and/or alternatively be performed by scanning tools of a type that would become apparent to one of ordinary skill in the art after reading the description herein, e.g., see scanning tools.

All layers of the container image determined to include the sensitive data are preferably, in some approaches, encrypted using a public key, while other layers of the container image determined to not include any sensitive are preferably not encrypted, e.g., see operation 408 which uses the public key 410 to create an encrypted version of the container image 412.

Operation 414 includes pushing the first container image to a container registry.

In response to receiving a requested for the container image, a bootloader may be caused, e.g., instructed, to check whether any of the layers of the container image are encrypted. In order to perform this check, the container image is pulled from the container registry (in operation 416) to a secure execution virtual machine 418 on which a private key 420 is stored. In some approaches, during the boot of a virtual server instance, the container image is decrypted using the private key which may be stored in a bootloader of the secure execution virtual machine 418. In response to a determination that the decryption fails for any encrypted layer, the virtual server is preferably terminated. In contrast, in response to a determination that the decryption is successful, the container image is in a state that is ready to be used. Accordingly, in some approaches, the encryption key may be deleted from the bootloader, as the image is ready to be booted. In some approaches, the container may then begin being used by an authorized and/or verified customer device that requests that the container image be booted.

One potential use case environment in which the techniques described herein may be deployed is based on IBM's Cloud Hyper Protect Virtual Servers for VPC (HPCR). Within such a use case, confidential computing may be enabled on LinuxONE (s390x processor architecture) by using the IBM Secure Execution for Linux technology. This technology is part of the hardware of IBM z15 (z15) and IBM LinuxONE III generation systems. With IBM Secure Execution for Linux, workloads are securely deployed in the cloud. This ensures the integrity and confidentiality of boot images, and server authenticity. Applications are isolated from the operating system, thus providing more privacy and security for the workload. A new operating system that leverages the IBM Secure Execution for Linux technology is now available as IBM Hyper Protect. The associated image that is used to create the instance is called the IBM Hyper Protect Container Runtime (HPCR) image. A virtual server instance that is provisioned by using this image is called as an IBM Cloud Hyper Protect Virtual Servers for VPC (Virtual Private Cloud) instance.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating an encryption key pair within a secure execution virtual machine, wherein the encryption key pair includes a private key and a public key;
storing the private key within the secure execution virtual machine;
determining whether any layers of a first container image contain sensitive data;
in response to a determination that a first of the layers of the first container image includes the sensitive data, using the public key to encrypt the first layer; and
in response to receiving a request for the first container image, using the private key to decrypt the first layer in the secure execution virtual machine.

2. The method of claim 1, further comprising:
in response to the determination that a second of the layers of the first container image does not include the sensitive data, not encrypting the second layer.

3. The method of claim 2, further comprising:
gathering information used to identify a pattern of the sensitive data in the first layer in the first container image;
storing the gathered information in a knowledge base;
use the identified pattern to perform a similarity comparison of the first layer and other layers in the first container image, the other layers including the second layer and a third layer;
in response to a determination that the third layer of the first container image includes the sensitive data, using the public key to encrypt the third layer; and
in response to receiving the request for the first container image, using the private key to decrypt the third layer in the secure execution virtual machine.

4. The method of claim 1, wherein the determining whether any of the layers of the first container image contain the sensitive data comprises: scanning the layers of the first container image, wherein the sensitive data is selected from the group consisting of: an API key, a secret, a proprietary code, a proprietary configuration, confidential data files, and confidential documents.

5. The method of claim 1, further comprising:
pushing the first container image with the encrypted first layer to a container registry; and
in response to receiving the request for the first container image, pulling the first container image with the encrypted first layer from the container registry into the secure execution virtual machine to decrypt the first layer in the secure execution virtual machine.

6. The method of claim 1, wherein the secure execution virtual machine is a protected central processing unit (CPU) enclave.

7. The method of claim 1, wherein the storing the private key within the secure execution virtual machine comprises: injecting the private key into a bootloader of the secure execution virtual machine.

8. The method of claim 7, further comprising:
in response to a determination that the first layer is successfully decrypted in the secure execution virtual machine, delete the private key from the bootloader.

9. The method of claim 8, wherein the private key is used to decrypt the first layer during provisioning of a virtual server instance on the secure execution virtual machine, and further comprising:
in response to a determination that the first layer is unsuccessfully decrypted in the secure execution virtual machine, terminating the virtual server instance.

10. A computer program product comprising:
one or more computer-readable storage media; and
program instructions stored on the one or more storage media to perform operations comprising:
generating an encryption key pair within a secure execution virtual machine, wherein the encryption key pair includes a private key and a public key;
storing the private key within the secure execution virtual machine;
determining whether any layers of a first container image contain sensitive data;
in response to a determination that a first of the layers of the first container image includes the sensitive data, using the public key to encrypt the first layer; and
in response to receiving a request for the first container image, using the private key to decrypt the first layer in the secure execution virtual machine.

11. The computer program product of claim 10, wherein the operations further comprise:
in response to a determination that a second of the layers of the first container image does not include the sensitive data, not encrypting the second layer.

12. The computer program product of claim 11, wherein the operations further
comprise:
gathering information used to identify a pattern of the sensitive data in the first layer in the first container image;
storing the gathered information in a knowledge base;
use the identified pattern to perform a similarity comparison of the first layer and other layers in the first container image, the other layers including the second layer and a third layer;
in response to a determination that the third layer of the first container image includes the sensitive data, using the public key to encrypt the third layer; and
in response to receiving the request for the first container image, using the private key to decrypt the third layer in the secure execution virtual machine.

13. The computer program product of claim 10, wherein the determining whether any of the layers of the first container image contain the sensitive data comprises: scanning the layers of the first container image, wherein the sensitive data is selected from the group consisting of: an API key, a secret, a proprietary code, a proprietary configuration, confidential data files, and confidential documents.

14. The computer program product of claim 10, wherein the operations further comprise:
pushing the first container image with the encrypted first layer to a container registry; and
in response to receiving the request for the first container image, pulling the first container image with the encrypted first layer from the container registry into the secure execution virtual machine to decrypt the first layer in the secure execution virtual machine.

15. The computer program product of claim 10, wherein the secure execution virtual machine is a protected central processing unit (CPU) enclave.

16. The computer program product of claim 10, wherein the storing the private key within the secure execution virtual machine comprises: injecting the private key into a bootloader of the secure execution virtual machine.

17. The computer program product of claim 16, wherein the operations further comprise:
in response to a determination that the first layer is successfully decrypted in the secure execution virtual machine, delete the private key from the bootloader.

18. The computer program product of claim 17, wherein the private key is used to decrypt the first layer during provisioning of a virtual server instance on the secure execution virtual machine, and wherein the operations further comprise:
in response to a determination that the first layer is unsuccessfully decrypted in the secure execution virtual machine, terminating the virtual server instance.

19. A computer system comprising:
a processor set;
one or more computer-readable storage media; and
program instructions stored on the one or more storage media to cause the processor set to perform operations comprising:
generating an encryption key pair within a secure execution virtual machine, wherein the encryption key pair includes a private key and a public key;
storing the private key within the secure execution virtual machine;
determining whether any layers of a first container image contain sensitive data;
in response to a determination that a first of the layers of the first container image includes the sensitive data, using the public key to encrypt the first layer; and
in response to receiving a request for the first container image, using the private key to decrypt the first layer in the secure execution virtual machine.

20. The computer system of claim 19, wherein the operations further comprise:
in response to a determination that a second of the layers of the first container image does not include the sensitive data, not encrypting the second layer.
